(19) United States
(12) Patent Application Publication
(10) Pub. No.: US 2026/0331682 A1
(43) Pub. Date: Oct. 22, 2026

(54) BATTERY UNIT AND DEVICE INCLUDING THE SAME

(71) Applicant: LG ENERGY SOLUTION, LTD., Seoul (KR)

(72) Inventors: Hyeok NAMGOUNG, Daejeon (KR); Hansu KIM, Daejeon (KR); Ji Won JEONG, Daejeon (KR); Daehoon LIM, Daejeon (KR); Jung Beom PARK, Daejeon (KR)

(73) Assignee: LG ENERGY SOLUTION, LTD., Seoul (KR)

(21) Appl. No.: 19/640,758

(22) Filed: Apr. 7, 2026

(30) Foreign Application Priority Data
Apr. 21, 2025 (KR) 10-2025-0051438
Feb. 26, 2026 (KR) 10-2026-0035629

(51) Int. Cl. H01M 50/264; H01M 50/211; H01M 50/242; H01M 50/249; H01M 50/271; H01M 50/502

(52) U.S. Cl. CPC H01M 50/264; H01M 50/211; H01M 50/242; H01M 50/249; H01M 50/271; H01M 50/502

(57) ABSTRACT

A battery unit includes: an end plate including first and second end plates that cover respective opposite side surfaces of a battery cell stack including a plurality of battery cells; and a fixing strap having a first end connected to the first end plate and a second end connected to the second end plate to couple the battery cell stack to the end plate. Each of the first end and the second end of the fixing strap includes an engaging portion having a fork shape, and the end plate includes a reinforcing portion engaged with the engaging portion.

### CROSS REFERENCES TO RELATED APPLICATIONS

This application is based on and claims priority from Korean Patent Application No. 10-2025-0051438, filed on Apr. 21, 2025 and Korean Patent Application No. 10-2026-0035629, filed on Feb. 26, 2026, with the Korean Intellectual Property Office, the disclosure of which is incorporated herein in its entirety by reference.

### TECHNICAL FIELD

The present disclosure relates to a battery unit and a device including the same.

### BACKGROUND

In modern society, as the use of energy storage systems (ESSs) and portable devices such as cell phones, laptops, camcorders, and digital cameras has become common, the development of technologies in the related fields has been actively pursued. Also, as a way to overcome the air pollution, and the like, caused by existing gasoline vehicles using fossil fuels, rechargeable secondary batteries are used as power sources for electric vehicles (EV), hybrid electric vehicles (HEV), and plug-in hybrid electric vehicles (P-HEV). Thus, the need to develop secondary batteries is increasing.

Commercially available secondary batteries in the present include nickel cadmium batteries, nickel hydrogen batteries, nickel zinc batteries, lithium secondary batteries, and the like. Among them, the lithium secondary batteries are attracting the most attention due to advantages such as free charging/discharging, a low self-discharge rate, and a high energy density.

In the case of secondary batteries used in small-sized devices, two to three battery cells are arranged, whereas in the case of secondary batteries used in medium- to large-sized devices such as vehicles, a battery module in which a plurality of battery cells are electrically connected is used. The capacity and power of the battery module is improved because the plurality of battery cells are connected to each other in series or parallel to form a battery cell stack. One or more battery modules may be mounted together with various control and protection systems such as a battery management system (BMS), a battery disconnect unit (BDU), and a cooling system, to form a battery pack.

Meanwhile, since battery modules or battery packs may be exposed to various external forces and vibrations during transportation and use, the battery cell stack may be safely protected. However, the protection structure of the conventional battery cell stack still needs to be improved in terms of structural stability and work efficiency.

### SUMMARY

In the present disclosure, a battery unit deformation caused by swelling of battery cells is minimized through a stable coupling between a fixing strap and an end plate and improvement of structural rigidity.

Also, in the present disclosure, the assembly capability of the fixing strap and the end plate is improved.

However, the technical tasks of the embodiment of the present disclosure are not limited to the above-described tasks and may be expanded in various ways within the scope of the technical ideas included in the present disclosure.

A battery unit according to one embodiment of the present disclosure includes: an end plate including first and second end plates that cover respective opposite side surfaces of a battery cell stack including a plurality of battery cells; and a fixing strap having a first end connected to the first end plate and a second end connected to the second end plate to couple the battery cell stack to the end plate. Each of the first end and the second end of the fixing strap may include an engaging portion having a fork shape, and the end plate may include a reinforcing portion engaged with the engaging portion.

The engaging portion may include at least two fork arms spaced apart from each other; and a fork groove formed between the at least two fork arms.

The reinforcing portion may include a reinforcing member into which the fork arms are inserted, and the fixing strap may include a bent portion bent such that the fork arms may be inserted into the reinforcing member.

The end plate may further include a fastening portion connected to the reinforcing member, a coupling hole may be formed in one end of the fixing strap to communicate with a fastening hole formed in the fastening portion, and the bent portion may be located between the engaging portion and the coupling hole.

The reinforcing portion may further include at least two insertion holes into which the at least two fork arms are inserted, respectively; and a partition portion that partitions the at least two insertion holes and is inserted into the fork groove.

The partition portion may have a columnar shape that extends in a direction perpendicular to the direction in which the at least two insertion holes are arranged.

The fork groove may have a groove shape elongated in a direction parallel to the extending direction of the at least two fork arms.

The fixing strap may include an extension portion that extends along the stacking direction of the plurality of battery cells and is disposed on at least one of an upper surface and a lower surface of the battery cell stack. The engaging portion may extend in a direction perpendicular to the extending direction of the extension portion and parallel to the surface of the end plate covering the battery cell stack.

The coupling hole may be formed between the extension portion of the fixing strap and the engaging portion, the fastening hole aligned with the coupling hole along one direction may be formed in the reinforcing portion, and the fixing strap may be fixed to the reinforcing portion by a fastening member inserted into the coupling hole and the fastening hole.

In a state where the engaging portion of the fixing strap is engaged with the reinforcing portion, the coupling hole and the fastening hole may be aligned with each other along the height direction of the battery unit.

The reinforcing portion may be formed on the outer surface of the end plate at the same level as the upper or lower surface of the battery cell stack.

The battery unit further includes a busbar frame assembly that is disposed on at least one of the front and rear surfaces of the battery cell stack to electrically connect the battery cells. The busbar frame assembly may include: a busbar frame disposed on the front surface or the rear surface of the battery cell stack; and a busbar mounted on the busbar frame and connected to the battery cells.

The partition portion is disposed between the at least two insertion holes, and supports one side and the other side of the reinforcing member along the extending direction of the partition portion, thereby reinforcing the structural rigidity of the reinforcing portion.

The at least two fork arms may be formed to be spaced apart from each other along a direction perpendicular to the stacking direction of the plurality of battery cells and the height direction of the battery unit, and parallel to the longitudinal direction of the battery cell.

The plurality of battery cells may be pouch-type battery cells each including an electrode assembly accommodated in a pouch case of a laminate sheet including a resin layer and a metal layer.

In the battery unit, the coupling hole and the fastening hole may be guided to be coaxially positioned by an engagement operation between the engaging portion of the fixing strap and the reinforcing portion. The coupling hole and the fastening hole may be aligned in a state where the fork arms are fully inserted into the insertion holes.

The reinforcing portion may have a structure in which the reinforcing member and the partition portion intersect with each other.

In the reinforcing portion, the reinforcing member and the partition portion may intersect to form a T shape in a plan view along the height direction of the battery unit.

A device according to one embodiment of the present disclosure may include the battery unit.

A vehicle according to one embodiment of the present disclosure may include the battery unit.

According to embodiments of the present disclosure, since a fixing strap and end plates are stably coupled, the structural rigidity is improved. Thus, this is effective in minimizing battery unit deformation caused by swelling of battery cells.

Also, according to embodiments of the present disclosure, it is effective in improving the assembly capability of the fixing strap and the end plates.

The effects of the present disclosure are not limited to those described above, and other effects that are not described herein may clearly be understood to those skilled in the art from the descriptions in the claims.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a perspective view of a battery unit, according to one embodiment of the present disclosure.

FIG. 2 is a view of the A portion of FIG. 1, in an enlarged scale.

FIG. 3 is a perspective view illustrating a portion of a fixing strap, according to one embodiment of the present disclosure.

FIG. 4 is a perspective view of a reinforcing portion, according to one embodiment of the present disclosure.

FIG. 5 is a plan view of the reinforcing portion illustrated in FIG. 4.

FIG. 6 is a view illustrating a connection structure of a strap and an end plate, according to one comparative example.

FIG. 7 is a view illustrating a connection structure of a strap and an end plate, according to another comparative example.

FIG. 8 is a perspective view of a vehicle including a battery unit, according to one embodiment of the present disclosure.

In some of the accompanying drawings, corresponding components are denoted with the same drawing symbols. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to the accompanying drawings to facilitate the practicing of the invention by one of ordinary skill in the art to which the present disclosure belongs. The present disclosure may be implemented in various different forms, and is not limited to the embodiments described herein.

In order to clearly describe the present disclosure, portions that are not related to the descriptions of the present disclosure will be omitted, and identical or similar components throughout the descriptions herein will be denoted by the same reference numerals.

In the drawings, the size and thickness of each component are arbitrarily illustrated for the convenience of descriptions, and the present disclosure is not necessarily limited to those illustrated in the drawings. In the drawings, the thickness is enlarged to clearly depict multiple layers and regions. Further, in the drawings, the thicknesses of some layers and regions are exaggerated for the convenience of description.

In the descriptions herein below, when an element such as a layer, film, region, or plate is present "above" or "on" a specific part, this description includes not only a case where the element is disposed "directly on" the specific part, but also a case where another part is present between the element and the specific part. Meanwhile, when an element is present "directly on" a specific part, this description indicates that another part is not present between the element and the specific part. Further, when an element is present "above" or "on" a reference portion, this description indicates that the element is disposed on or under the reference portion, and does not necessarily indicate that the element is disposed "above" or "on" the reference portion against the direction of gravity.

Meanwhile, although terms indicating directions, such as up, down, left, right, front, and back, may be used in the present specification, it is obvious to those skilled in the art of the present disclosure that these terms are only for convenience of explanation, and may vary depending on the location of a target object, the location of an observer, etc.

Throughout the descriptions herein, when a certain part "includes" a specific component, this description does not indicate that the certain part excludes other components, but indicates that the certain part may further include other components, unless otherwise defined.

Also, through the specification, the term "planar" refers to a top view of a target portion, and the term "cross-sectional" refers to a side view of a vertically cut section of a target portion.

Since battery modules or battery packs may be exposed to various external forces and vibrations during transportation and use, a battery cell stack needs to be safely protected. Also, it is necessary to minimize deformation that is caused by swelling of battery cells due to repeated use. To this end, end plates that serve to provide protection and support may be disposed on both sides of the battery cell stack. Then, a strap may be additionally used, which is coupled to the end plates while surrounding the battery cell stack.

In general, the strap may be coupled to the end plates through a bolt fastening method. However, in the bolt fastening method, the fastening strength may be reduced due to external impact and vibration. Also, there is a possibility that local stress may be concentrated on the strap and the end plates, leading to damage. Also, since there is no means of fixing the strap and the end plates other than bolts, it is difficult to expect more stable coupling and improved structural rigidity. Then, holes for bolt fastening must be additionally aligned, causing inconvenience in the assembly process. Therefore, a structure with improved structural rigidity and improved assembly capability is needed in which the strap and the end plates are stably coupled.

In consideration of these points, the present disclosure provides a battery unit in which battery unit deformation caused by swelling of battery cells is minimized through the stable coupling between a fixing strap and an end plate and improvement of structural rigidity.

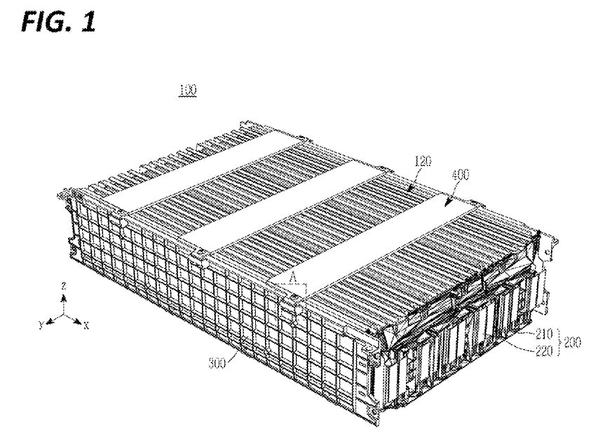

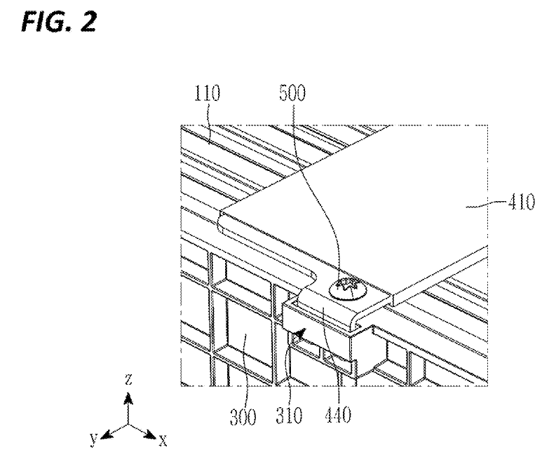

FIG. 1 is a perspective view of a battery unit 100, according to one embodiment of the present disclosure. FIG. 2 is a view of the A portion of FIG. 1, in an enlarged scale.

Referring to FIGS. 1 and 2, the battery unit 100 according to one embodiment of the present disclosure may include a battery cell stack 120 in which a plurality of battery cells 110 are stacked, a busbar frame assembly 200 disposed on at least one side of the battery cell stack 120, an end plate 300 that covers at least one surface of the battery cell stack 120, and a fixing strap 400 that couples the battery cell stack 120 to the end plate 300.

The battery cell 110 may be a pouch-type battery cell. The battery cell 110 may be manufactured by housing an electrode assembly in a pouch case of a laminate sheet, and thermally bonding a sealing portion of the pouch case. The laminate sheet includes a resin layer and a metal layer. The plurality of battery cells 110 may be configured, and the battery cells 110 may be stacked to form the battery cell stack 120 in which the battery cells 110 are electrically connected to each other.

The busbar frame assembly 200 may be disposed on at least one side of the battery cell stack 120. The busbar frame assemblies 200 may be disposed on the front and rear surfaces of the battery cell stack 120, respectively, and may be connected to the battery cell stack 120. The busbar frame assembly 200 may include a busbar frame 210 disposed on at least one side of the battery cell stack 120 and a busbar 220 mounted on the busbar frame 210 and connected to the plurality of battery cells 110. The busbar frames 210 may be disposed on the front and rear surfaces of the battery cell stack 120, respectively. The busbar frame assembly 200 may allow the plurality of battery cells 110 to be electrically connected to each other. The busbar frame assembly 200 may electrically connect the plurality of battery cells 110 to an external battery management system (BMS), etc. The busbar frame assemblies 200 disposed on the front and rear surfaces of the battery cell stack 120, respectively, may be electrically connected to each other by using a flexible flat cable (FFC), and the like. The busbar frame assembly 200 may be configured to measure voltage and temperature information of the battery cells 110 and to transmit the information to the external BMS.

The end plate 300 may cover at least one surface of the battery cell stack 120. The end plates 300 may cover both side surfaces of the battery cell stack 120. Both side surfaces of the battery cell stack 120 covered by the end plates 300 may be surfaces perpendicular to the front and rear surfaces of the battery cell stack 120 on which the busbar frame assemblies 200 are disposed. The fixing strap 400 may be coupled to the end plates 300. The end plate 300 may include a reinforcing portion 310 coupled to an engaging portion 420 of the fixing strap 400 to be described below. The reinforcing portion 310 may be formed on the outer surface of the end plate 300.

The fixing strap 400 may couple the battery cell stack 120 to the end plates 300. For example, both ends of the fixing strap 400, for example, the first end and the second end may be connected to the end plates 300, respectively, which cover both side surfaces of the battery cell stack 120, respectively. As described below, the engaging portions 420 formed at both ends of the fixing strap 400, respectively, may be inserted into the reinforcing portions 310 formed on the end plates 300 so as to connect the fixing strap 400 to the end plates 300.

The fixing strap 400 may include an extension portion 410 disposed to cross the upper or lower surface of the battery cell stack 120, and the engaging portion 420 coupled to the end plate 300. Here, the upper and lower surfaces of the battery cell stack 120 may be surfaces perpendicular to the above-described front and rear surfaces and both side surfaces of the battery cell stack 120. The extension portion 410 may be disposed on at least one of the upper and lower surfaces of the battery cell stack 120. The extension portion 410 may be elongated in a direction beginning from the first end of the fixing strap 400 toward the second end. The extension portion 410 may be formed to be elongated along the first direction, that is, the stacking direction of the battery cell stack 120 (e.g., the y-axis direction in FIG. 1). The engaging portions 420 may extend from both ends of the extension portion 410 and may be coupled to the reinforcing portions 310 formed on the end plates 300. The engaging portion 420 may extend in a direction perpendicular to the extension direction of the extension portion 410. The engaging portion 420 may extend in a direction parallel to the end plate 300. A bent portion 440, which is at least partially bent, may be formed on the fixing strap 400 so that the engaging portion 420 may be inserted into a reinforcing member 311 formed on the end plate 300 to be described below. Accordingly, the extension portion 410 and the engaging portion 420 of the fixing strap 400 may extend in perpendicular directions. Since the extension portion 410 of the fixing strap 400 extends along the stacking direction of the battery cell stack 120 and the engaging portion 420 is coupled to the end plate 300, the battery unit 100 may be suppressed from being deformed due to swelling of the battery cells 110. The fixing strap 400 may be made of a metal material, but the present disclosure is not necessarily limited thereto. A plurality of fixing straps 400 may be provided. The fixing straps 400 may be arranged such that the extension portions 410 may cross the upper and/or lower surface of the battery cell stack 120, and the engaging portions 420 may be coupled to the end plates 300.

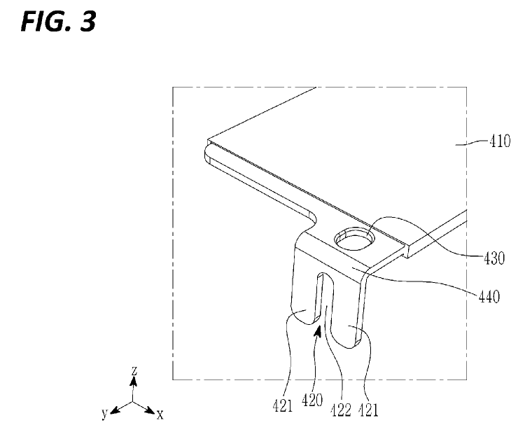

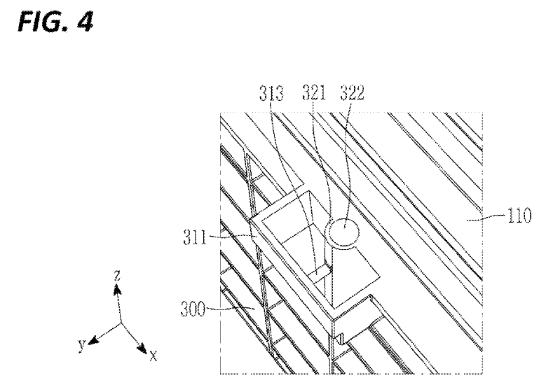

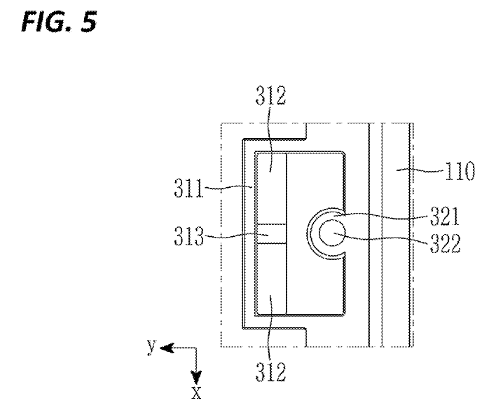

FIG. 3 is a perspective view illustrating a portion of the fixing strap 400, according to one embodiment of the present disclosure. This drawing illustrates a portion of the extension portion 410 of the fixing strap 400, the engaging portion 420, a coupling hole 430, and the bent portion 440. FIG. 4 is a perspective view of the reinforcing portion 310, according to one embodiment of the present disclosure. FIG. 5 is a plan view of the reinforcing portion 310 illustrated in FIG. 4.

First, referring to FIG. 3, the engaging portions 420 may be formed at both ends of the fixing strap 400, i.e., the first end and the second end. The engaging portions 420 may be formed to extend from both ends of the extension portion 410. The engaging portion 420 may extend in a direction perpendicular to the extension direction of the extension portion 410. For example, when the extension portion 410 extends along the first direction, i.e., the stacking direction of the battery cells 110, the engaging portion 420 may extend in the second direction perpendicular to the first direction. Here, the second direction may be a direction parallel to the height direction of the battery unit 100, and the height direction of the battery unit 100 means a direction from the lower surface of the battery cell stack 120 toward the upper surface (e.g., the z-axis direction in FIGS. 1-3). The engaging portion 420 may extend in a direction perpendicular to the extension direction of the extension portion 410 so as to be parallel to the surface of the end plate 300 covering the battery cell stack 120. The bent portion 440 may be formed between the extension portion 410 and the engaging portion 420. For example, the bent portion 440 may be located between the engaging portion 420 and the coupling hole 430 to be described below.

The engaging portion 420 may be formed in a fork shape. For example, the engaging portion 420 may include at least two fork arms 421 which are spaced apart from each other. The fork arms 421 may be formed to extend in a direction perpendicular to the extension direction of the extension portion 410. For example, when the extension portion 410 is formed to extend in the first direction, i.e., the stacking direction of the battery cells 110, the fork arms 421 may be formed to extend in the second direction perpendicular to the first direction. Here, the second direction may be a direction parallel to the height direction of the battery unit 100. The fork arms 421 may be spaced apart from each other in the third direction perpendicular to the first direction and the second direction. The third direction may be a direction parallel to the longitudinal direction of the battery cell 110. Here, the longitudinal direction of the battery cell 110 (e.g., the x-axis direction in FIGS. 1-3) means a direction perpendicular to the stacking direction of the battery cells 110 (e.g., the y-axis direction in FIGS. 1-3) and the height direction of the battery unit 100 (e.g., the z-axis direction in FIGS. 1-3).

A fork groove 422 may be formed between the fork arms 421 relative to a direction in which the fork arms 421 are spaced apart from each other. The fork groove 422 may mean a space between the fork arms 421 spaced apart from each other. The fork groove 422 may have a groove shape elongated in a direction parallel to the extension direction of the fork arms 421. When the fixing strap 400 and the end plate 300 are coupled, the fork arms 421 of the engaging portion 420 may be inserted into insertion holes 312 of the reinforcing portion 310 to be described below, and a partition portion 313 of the reinforcing portion 310 to be described below may be inserted into the fork groove 422.

The coupling hole 430 into which a fastening member 500 (see, e.g., FIG. 2) is inserted may be formed at one end of the fixing strap 400. The coupling hole 430 may be formed between the extension portion 410 and the engaging portion 420 of the fixing strap 400. Alternatively, the coupling hole 430 may be formed between the extension portion 410 and the bent portion 440 of the fixing strap 400. The coupling hole 430 may be formed to communicate with a fastening hole 322 formed in a fastening portion 321 of the end plate 300. The coupling hole 430 may be formed through a portion of the fixing strap 400, along a direction parallel to the height direction of the battery unit 100 which is the extension direction of the engaging portion 420. Here, the fastening member 500 may be a bolt, but is not necessarily limited thereto.

Referring to FIGS. 4 and 5, the reinforcing portion 310 that is coupled to the engaging portion 420 of the fixing strap 400 may be formed on the end plate 300. The reinforcing portion 310 may be formed on the outer surface of the end plate 300. The reinforcing portion 310 may be formed adjacent to the upper or lower surface of the battery cell stack 120, on the outer surface of the end plate 300. The reinforcing portion 310 may be formed on the outer surface of the end plate 300, at the same level as the upper or lower surface of the battery cell stack 120. The engaging portion 420 of the fixing strap 400 may be connected to the reinforcing portion 310, and thus, the fixing strap 400 and the end plate 300 may be coupled.

The reinforcing portion 310 may be formed in a shape that engages with the engaging portion 420 of the fixing strap 400. For example, the reinforcing portion 310 may include the reinforcing member 311. As illustrated in FIG. 5, the reinforcing member 311 may form a "T" shape together with the partition portion 313 to be described below when viewed in the -z-axis direction on the drawing. The reinforcing portion 310 may include at least two insertion holes 312. The insertion hole 312 may have a through-hole shape formed along a direction parallel to the extension direction of the fork arms 421 of the fixing strap 400. When the fixing strap 400 and the end plate 300 are coupled, the fork arms 421 of the fixing strap 400 may be inserted into the insertion holes 312 of the reinforcing member 311, respectively.

The reinforcing portion 310 may include the partition portion 313 that is formed between the insertion holes 312 and separates the insertion holes 312. The partition portion 313 may be arranged between the insertion holes 312 relative to a direction parallel to the longitudinal direction of the battery cell 110. Here, a direction parallel to the longitudinal direction of the battery cell 110 means a direction perpendicular to the first direction in which the battery cells 110 are stacked and the second direction in which the insertion holes 312 are formed as through holes. Accordingly, the insertion holes 312 may be arranged to be separated from each other in a direction parallel to the longitudinal direction of the battery cell 110.

The partition portion 313 may have a columnar shape that extends in a direction perpendicular to the direction in which the insertion holes 312 are arranged. For example, the insertion holes 312 may be arranged in a direction parallel to the longitudinal direction of the battery cell 110, and the partition portion 313 may have a shape extending along the stacking direction of the battery cells 110 perpendicular to the longitudinal direction of the battery cell 110. The partition portion 313 disposed between the insertion holes 312 may support one side and the other side of the reinforcing member 311 along the extension direction of the partition portion 313, thereby improving the structural rigidity of the reinforcing portion 310. When the fixing strap 400 and the reinforcing portion 310 are coupled, the partition portion 313 may be inserted into the fork groove 422 of the fixing strap 400.

According to one embodiment, the reinforcing portion 310 may have a characteristic intersection structure to maximize the stability of coupling with the fixing strap 400. For example, in the reinforcing portion 310, the reinforcing member 311 forming the insertion holes 312, and the partition portion 313 disposed between the insertion holes 312 may be integrally formed while intersecting each other. According to this intersection structure, the reinforcing portion 310 may have a "T" shape as a whole in a plan view along the height direction of the battery unit 100 (for example, the -z-axis direction). Then, due to this T-shape intersection structure, it is possible to naturally define the partition portion 313 that physically separates the insertion holes 312 from each other. Also, in the T-shaped reinforcing portion 310, both sides of the reinforcing member 311 may be supported through the partition portion 313. Thus, it is possible to improve structural rigidity resisting stress caused by external impact or battery cell swelling.

Meanwhile, the end plate 300 may further include the fastening portion 321 connected to the reinforcing member 311. The fastening hole 322 into which the fastening member 500 is inserted may be formed in the fastening portion 321. In a state where the engaging portion 420 of the fixing strap 400 is engaged with the reinforcing portion 310, the coupling hole 430 and the fastening hole 322 may be aligned with each other. For example, the coupling hole 430 and the fastening hole 322 may be aligned with each other along the height direction of the battery unit 100 in a state where the fork arms 421 of the fixing strap 400 are inserted into the insertion holes 312 of the reinforcing portion 310 and the partition portion 313 of the reinforcing portion 310 is inserted into the fork groove 422 of the fixing strap 400. When the extension portion 410 of the fixing strap 400 is disposed on the upper surface of the battery cell stack 120, the coupling hole 430 and the fastening hole 322 may be aligned with each other along a direction from the upper surface of the battery cell stack 120 toward the lower surface. When the extension portion 410 of the fixing strap 400 is disposed on the lower surface of the battery cell stack 120, the coupling hole 430 and the fastening hole 322 may be aligned with each other along a direction from the lower surface of the battery cell stack 120 toward the upper surface. In a state where the coupling hole 430 and the fastening hole 322 are aligned along the height direction of the battery unit 100, the fastening member 500 may be inserted into the coupling hole 430 and the fastening hole 322 so as to fix the fixing strap 400 to the reinforcing portion 310.

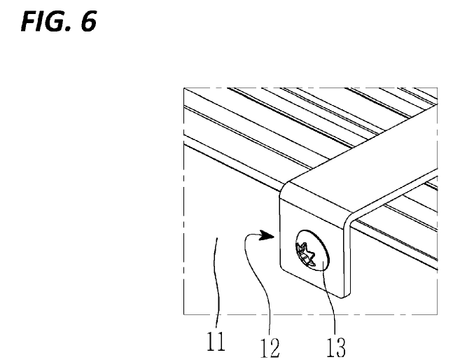

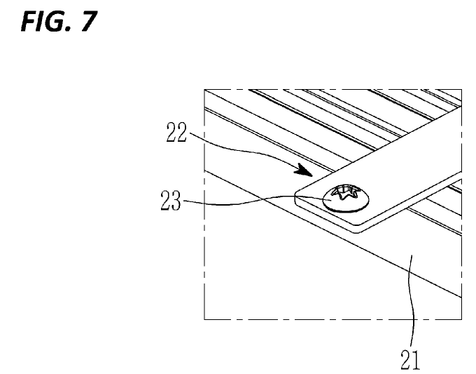

FIG. 6 is a view illustrating a connection structure of a strap 12 and an end plate 11 according to one comparative example. FIG. 7 is a view illustrating a connection structure of a strap 22 and an end plate 21 according to another comparative example.

First, referring to FIG. 6, in one comparative example, the strap 12 may be formed such that its end is parallel to the end plate 11. In a state where the end of the strap 12 is in contact with the outer surface of the end plate 11, a bolt 13 may be fastened through the end of the strap 12 and the end plate 11.

Also, referring to FIG. 7, in another comparative example, the strap 22 may have a straight line shape that is simply elongated. In a state where the end of the strap 22 is seated on a narrow upper surface perpendicular to the outer surface of the end plate 21, a bolt 23 may be fastened from above.

As described above, according to comparative examples, since there is no means of fixing the straps 12 and 22 to the end plates 11 and 21 other than fastening of the bolts 13 and 23, it is difficult to expect more stable coupling and improved structural rigidity, and there are limitations in preventing deformation caused by swelling of the battery cells. Also, in order to fasten the bolts 13 and 23, holes formed in the end plates 11 and 21 and the straps 12 and 22 have to be additionally aligned, thereby causing inconvenience in the assembly process.

In the meantime, referring back to FIGS. 2-5, the battery unit 100 according to one embodiment of the present disclosure has an engagement structure in which the fork arms 421 of the fixing strap 400 are inserted into the insertion holes 312 of the reinforcing portion 310, and the partition portion 313 of the reinforcing portion 310 is inserted into the fork groove 422 of the fixing strap 400. Accordingly, the fixing strap 400 may be more stably coupled to the end plate 300, thereby improving the structural rigidity of the battery unit 100. Then, it is possible to minimize deformation of the battery unit 100 caused by swelling of the battery cells.

Also, since the engaging portion 420 of the fixing strap 400 and the reinforcing portion 310 form an engagement structure, the engaging portion 420 of the fixing strap 400 may be easily inserted into the reinforcing portion 310. When the engaging portion 420 of the fixing strap 400 is inserted into the reinforcing portion 310, the coupling hole 430 and the fastening hole 322 are aligned with each other. Thus, there is no need to additionally align the holes in insertion of the fastening member 500, thereby improving assembly capability.

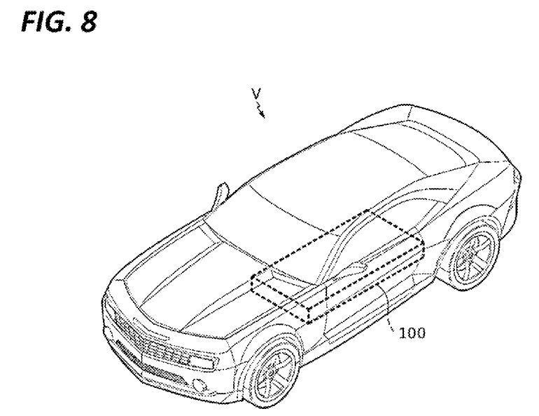

FIG. 8 is a view for explaining a vehicle, according to one embodiment of the present disclosure.

The above-described battery unit 100 may include a battery module or a battery pack, and the battery unit 100 may be applied to various devices. These devices include transportation means such as electric bicycles, electric vehicles, and hybrid vehicles.

Referring to FIG. 8, since the vehicle V according to the present embodiment includes the battery unit 100 of the previous embodiment, it is possible to realize the vehicle V having all the advantages of the previous embodiment. Also, the device described above is not limited thereto, and may be applied to various devices capable of using the battery unit 100 and the battery pack including the same, which falls within the scope of the present invention.

While the embodiments of the present disclosure have been described, the scope of the present disclosure is not limited thereto. Various modifications and changes made by those skilled in the art based on the technical idea of the present disclosure defined in the following claims also fall within the scope of the present disclosure.

What is claimed is:

1. A battery unit comprising:
an end plate including first and second end plates configured to cover respective opposite side surfaces of a battery cell stack including a plurality of battery cells; and
a fixing strap having a first end connected to the first end plate and a second end connected to the second end plate, and configured to couple the battery cell stack to the end plate,
wherein each of the first end and the second end of the fixing strap includes an engaging portion having a fork shape, and
the end plate includes a reinforcing portion engaged with the engaging portion.

2. The battery unit according to claim 1, wherein the engaging portion includes:
at least two fork arms spaced apart from each other; and
a fork groove formed between the at least two fork arms.

3. The battery unit according to claim 2, wherein the reinforcing portion includes a reinforcing member into which the fork arms are inserted, and
the fixing strap includes a bent portion that is bent such that the fork arms are inserted into the reinforcing member.

4. The battery unit according to claim 3, wherein
the end plates further include a fastening portion connected to the reinforcing member,
a coupling hole is formed in one end of the fixing strap to communicate with a fastening hole formed in the fastening portion, and
the bent portion is located between the engaging portion and the coupling hole.

5. The battery unit according to claim 3, wherein the reinforcing portion further include:
at least two insertion holes into which the at least two fork arms are inserted, respectively; and
a partition portion configured to partition the at least two insertion holes and inserted into the fork groove.

6. The battery unit according to claim 5, wherein the partition portion has a columnar shape extending in a direction perpendicular to the direction in which the at least two insertion holes are arranged.

7. The battery unit according to claim 2, wherein the fork groove has a groove shape elongated in a direction parallel to an extending direction of the at least two fork arms.

8. The battery unit according to claim 1, wherein the fixing strap includes an extension portion extending along a stacking direction of the plurality of battery cells and disposed on at least one of an upper surface and a lower surface of the battery cell stack,
the engaging portion extends in a direction perpendicular to an extending direction of the extension portion and parallel to a surface of the end plate covering the battery cell stack.

9. The battery unit according to claim 8, wherein
the coupling hole is formed between the extension portion of the fixing strap and the engaging portion,
the fastening hole aligned with the coupling hole along one direction is formed in the reinforcing portion, and
the fixing strap is fixed to the reinforcing portion by a fastening member inserted into the coupling hole and the fastening hole.

10. The battery unit according to claim 9, wherein in a state where the engaging portion of the fixing strap is engaged with the reinforcing portion, the coupling hole and the fastening hole are aligned with each other along a height direction of the battery unit.

11. The battery unit according to claim 1, wherein the reinforcing portion is formed on an outer surface of the end plate at the same level as an upper or lower surface of the battery cell stack.

12. The battery unit according to claim 1, further comprising:
a busbar frame assembly disposed on at least one of the front and rear surfaces of the battery cell stack to electrically connect the battery cells,
wherein the busbar frame assembly includes: a busbar frame disposed on the front surface or the rear surface of the battery cell stack, and a busbar mounted on the busbar frame and connected to the battery cells.

13. The battery unit according to claim 5, wherein the partition portion is disposed between the at least two insertion holes, and supports one side and a remaining side of the reinforcing member along an extending direction of the partition portion, thereby reinforcing the structural rigidity of the reinforcing portion.

14. The battery unit according to claim 2, wherein the at least two fork arms are formed to be spaced apart from each other along a direction perpendicular to a stacking direction of the plurality of battery cells and a height direction of the battery unit, and parallel to a longitudinal direction of the battery cell.

15. The battery unit according to claim 1, wherein the plurality of battery cells are pouch-type battery cells each having an electrode assembly accommodated in a pouch case of a laminate sheet including a resin layer and a metal layer.

16. The battery unit according to claim 10, wherein the coupling hole and the fastening hole are guided to be coaxially positioned by an engagement operation between the engaging portion of the fixing strap and the reinforcing portion, and
the coupling hole and the fastening hole are aligned in a state where the fork arms are fully inserted into the insertion holes.

17. The battery unit according to claim 5, wherein the reinforcing portion has a structure in which the reinforcing member and the partition portion intersect each other.

18. The battery unit according to claim 17, wherein the reinforcing portion has a structure in which the reinforcing member and the partition portion intersect to form a T shape in a plan view along a height direction of the battery unit.

19. A device comprising the battery unit according to claim 1.

20. A vehicle comprising the battery unit according to claim 1.
